(19) United States
(12) Patent Application Publication
(10) Pub. No.: US 2005/0285856 A1
(43) Pub. Date: Dec. 29, 2005

(54) Method for generating a realistic representation

(76) Inventor: Norbert Gruntjens, Dunningen (DE)

Correspondence Address: BACHMAN & LAPOINTE, P.C., 900 CHAPEL STREET, SUITE 1201, NEW HAVEN, CT, 06510, US

(21) Appl. No.: 11/020,745

(22) Filed: Dec. 23, 2004

(30) Foreign Application Priority Data
Jun. 25, 2004 (DE) 10 2004 030 876.4

(51) Int. Cl. G06T 15/00; G09G 5/00

(52) U.S. Cl. 345/419; 345/582

(57) ABSTRACT

In a method for generating a realistic representation of an environment in a computer by means of a 3D model, a texture being selected for an area of the environment and being laid onto the area, areas of the environment are intended to be covered with a texture from the viewing angle of the observer.

### BACKGROUND OF THE INVENTION

The invention relates to a method for generating a realistic representation in a computer by means of a 3D model, a texture being selected for an area of the representation and being laid onto the area.

### PRIOR ART

In order to generate a realistic 3D landscape in a computer, the underlying model has to receive a texturing that is as real as possible. Highly structured surfaces (tiled roofs, grass, cities in an aerial image) have a different appearance depending on the viewing angle since the individual structure elements of the surface may have specific preferred directions and conceal other structure elements. In the case of a city, by way of example, roofs and streets can principally be seen in the case of a viewing direction perpendicularly downward, while in the case of an oblique viewing direction the side walls are principally visible and the streets are largely concealed by the buildings.

The representation of 3D objects can be improved if a texture that shows the structure elements in a direction similar to the viewing direction is used instead of a texture corresponding to the perpendicular plan view.

In order to combat this problem, nowadays a part of the object which is actually concealed is photographed. This image fragment is then used for the entire concealed object. This means, however, that the object itself and also the concealed region appear unrealistic since, by way of example, details in the boundary region of the two objects are missing or, for example, a shadow of the object on a following area is missing. Moreover, the object itself has a uniform and unrealistic effect due to the continually repeating texture.

It is an object of the present invention to provide a method of the above-mentioned type which generates a substantially realistic representation.

### SUMMMARY OF THE INVENTION

This object is achieved by virtue of the fact that areas of the environment are covered with a texture from the viewing angle of the observer.

### DETAILED DESCRIPTION

At the point of the only possible observer position, the environment is acquired photographically in a single contiguously recorded texture such that, by means of suitable software, the user can be presented with the corresponding view of the scene for all conceivable viewing directions in the acquisition range. In the ideal case, the horizontal acquisition range will be 360° and the vertical acquisition range will be 180°, which permits the user to fully explore the recorded scene. Smaller acquisition ranges are likewise possible; by way of example the vertical acquisition range is then limited to 150°, only the lowermost 30° of the total vertical light field that encompasses 180° being withheld from the user.

The panoramic image produced correspondingly enables the user to be placed in a virtual world and, in the process, to be presented with absolutely photorealistic images of this world.

In a further possibility of the invention, it is provided that an area is covered with different textures and/or texture combinations during the running time of the application in a manner dependent on the viewing angle of the viewer.

This method according to the invention effects a. dynamic continuously changing representation of an object, depending on the viewing angle of the viewer. In this case, an optimized texturing is performed, to be precise with regard to texture selection and texture coordinate generation. In this case, the method works with a 3D model comprising individual objects and a set of textures. During the program run, for each object, the texture is selected from a set of textures and the texture coordinates are generated for this combination of object and texture. In this case, the texture to be used is selected from a set of textures such that an optimum result is obtained for the respective object and the viewing direction. The set of textures from which a selection can be made may comprise, for example, recordings of the objects or rendered views of a more highly resolved 3D model of the object. The actual representation of the 3D object (rendering) remains unaffected by the method.

The two-dimensional structure of the panoramic image should also be enriched with further information items. These include primarily depth information items, and also information items regarding properties, functions and relationships of the object in the virtual world. While the definition of general object properties depends greatly on the conditions of the individual application, the depth information is accorded a central significance in the case of 3D modeling and processing. It defines the spatial position and extent of objects and is thus the basis for the simulation of physical processes, such as e.g. movements, collisions or contact with the ground. At the pixel level, the presence of depth information items is necessary for defining that dynamic objects are concealed by static or other dynamic objects at a lesser distance. Moreover, a pixel-related depth information item makes it possible to provide the scene with shadows generated by dynamic objects.

During the programming of the dynamic objects, particular attention is directed at ensuring that the representation is effected just as realistically as the rest of the scene. For this purpose, the illumination situation acquired in the panoramic image is simulated from the following standpoint:
position and characteristic of light sources
proportion of direct light
light colors
mist and fog

The surface properties of the objects that become visible on the basis of light reflections are likewise simulated, preferably realistically.

1. A method for generating a realistic representation of an environment in a computer by means of a 3D model, comprising selecting a texture for an area of the environment and laying the texture onto the area,
wherein the area of the environment is covered with the texture from a viewing angle of an observer.

2. A method for generating a realistic representation of an environment in a computer by means of a 3D model, comprising selecting at least one texture for an area of the environment and spraying the texture onto the area, wherein the area is covered with one or more textures during running time of an application in a manner dependent on a viewing angle of a viewer.

3. The method as claimed in claim 1, wherein the texture is imparted pixel-related depth information items for the representation of position, extent, motion, shadows, collisions, contact with the ground, or the like of dynamic objects.

4. The method as claimed in claim 2, wherein the texture is imparted pixel-related depth information items for the representation of position, extent, motion, shadows, collisions, contact with the ground, or the like of dynamic objects.
